(19) United States
(12) Patent Application Publication
(10) Pub. No.: US 2009/0004586 A1
(43) Pub. Date: Jan. 1, 2009

(54) Polymer Blends For Light Sensitive Photoconductor

(76) Inventors: Mark Thomas Bellino, Loveland, CO (US); David Glenn Black, Longmont, CO (US); Dat Quoc Nguyen, Pllatteville, CO (US); Weimei Luo, Louisville, CO (US); Scott Daniel Reeves, Louisville, CO (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 11/771,381

(22) Filed: Jun. 29, 2007

(51) Int. Cl. G03G 5/047

(52) U.S. Cl. 430/59.5; 430/133; 430/57.1; 430/59.1

(57) ABSTRACT

The present disclosure relates to an electrophotoconductive element comprising a conductive substrate, a charge generation layer including a charge generating compound and a charge transport layer. The charge generation layer includes a first polymer resin and second polymer resin to provide a blend including the charge generating compound. The first polymer resin may therefore indicate an energy at a half charge potential E_{0.5(POLYMER)} upon exposure to light at a wavelength of about 350-500 nm. The blend then also indicates an energy at half charge potential E_{0.5(BLEND)} upon exposure to light at a wavelength of about 350-500 nm. The second polymer resin of the blend is therefore selected to provide that E_{0.5(BLEND)}<E_{0.5(POLYMER).}

### CROSS REFERENCES TO RELATED APPLICATIONS

None.

### STATEMENT REGARDING FEDERALLY SPONSORED RESEARCH OR DEVELOPMENT

None.

### REFERENCE TO SEQUENTIAL LISTING, ETC.

None.

### BACKGROUND

1. Field of the Invention

The present invention relates generally to photoconductors including a charge generating layer containing a blend of polymers that is sensitive to selected wavelengths of light.

2. Description of the Related Art

A photoconductive device for an electrophotographic imaging system may include a conductive substrate coated with a charge generation layer (CGL) which in turn may be coated with a charge transfer layer (CTL). Typically, such devices may be configured to have relatively useful levels of sensitivity to a relatively long wavelength region of approximately 700-800 nm. Accordingly, such devices may rely upon charge generation materials, which while sensitive to wavelengths of 700-800 nm, do not generally exhibit absorption bands at about 400-500 nm. However, photogeneration using a lower wavelength may be desirable as shorter wavelength irradiation may provide relatively higher resolution printing.

In addition, as printers are expected to perform at relatively fast speeds, it becomes important that the photoconductor charge and discharge occur at relatively short intervals. The time frames requires for 35 ppm (page per minute) printing, for example, could relate to an expose-to-develop time in the order of 40-80 ms. There is therefore a need for systems that improve the electrophotographic properties of a given electrophotoconductive element.

### SUMMARY OF THE INVENTION

In a first exemplary embodiment, the present disclosure relates to an electrophotoconductive element comprising a conductive substrate, a charge generation layer including a charge generating compound and a charge transport layer. The charge generating layer includes a first polymeric resin and a second polymer resin forming a blend wherein the blend provides an energy at half charge potential E_{0.5(BLEND)} upon exposure to light at a wavelength of about 350-500 nm. The first polymer resin also provides an energy at half charge potential E_{0.5(POLYMER)} upon exposure to light at a wavelength of about 350-500 nm, wherein E_{0.5(BLEND)}<E_{0.5(POLYMER)}.

In another exemplary embodiment, the present disclosure again relates to an electrophotoconductive element comprising a conductive substrate, a charge generation layer including a charge generating compound and a charge transport layer. The charge generating layer (CGL) may include a charge generating compound and a poly(vinyl acetal) having the following formula:

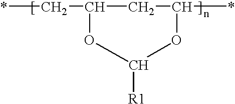

where R1 may be a substituted or unsubstitututed aliphatic or aromatic group or a combined aliphatic-aromatic group. A second polymer resin is provided thereby forming a blend, where the second polymer resin has the formula:

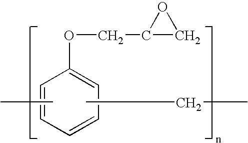

The blend then provides an energy at half charge potential E_{0.5(BLEND)} upon exposure to light at a wavelength of about 350-500 nm and the poly(vinyl acetal) provides an energy at half charge potential E_{0.5(PVA)} upon exposure to light at a wavelength of about 350-500 nm, wherein E_{0.5(BLEND)}<E_{0.5(PVA).}

In another exemplary embodiment, the present disclosure is directed at a method for improving the spectral sensitivity of a photoconductor containing a conductive substrate, a charge generation layer including a charge generating compound and a charge transport layer. The method includes forming a charge generation layer by combining a first polymer resin and second polymer resin to provide a blend including a charge generating compound. The first polymer resin may therefore indicate an energy at half charge potential E_{0.5(POLYMER)} upon exposure to light at a wavelength of about 350-500 nm. The blend then also indicates an energy at half charge potential E_{0.5(BLEND)} upon exposure to light at a wavelength of about 350-500 nm. The second polymer resin of the blend is therefore selected to provide that E_{0.5(BLEND)}<E_{0.5(POLYMER).}

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 illustrates an exemplary imaging unit in an image forming device,

FIG. 2 is a cross-sectional view of an exemplary photoconductor;

FIG. 3 is an exemplary x-ray diffraction pattern for type I TiOPC;

FIG. 4 is an exemplary x-ray diffraction pattern for type IV TiOPC;

FIG. 5 illustrates exemplary solution and solid state absorption curves for TiOPC over a given range of wavelengths;

FIG. 6 illustrates an exemplary potential versus energy/area plot for a photoconductor surface; and

FIG. 7 illustrates representative discharge voltage curves for various blends containing TiOPC (45% by weight) as compared to poly(vinyl butyral) (PVB) resin containing TiOPC (45% by weight) as a function of light energy at 405 nm expressed in microjoules per square centimeter (μJ/cm²).

### DETAILED DESCRIPTION

It is to be understood that the invention is not limited in its application to the details of construction and the arrangement of components set forth in the following description or illustrated in the drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings.

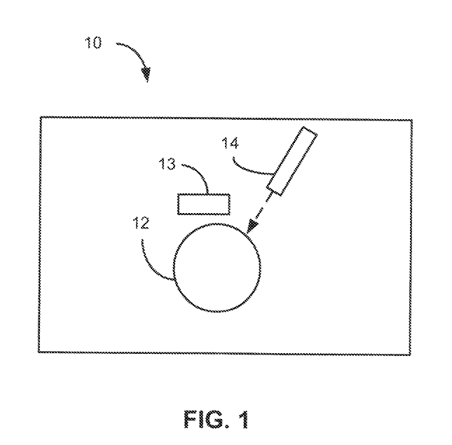

As illustrated in FIG. 1, an exemplary imaging unit may be located in an image forming device 10. The imaging unit may include an electrophotoconductive element 12 used in combination with a charging device 13 and a light emitting source 14. The charging device may be, for example, a corona treatment device or a charging roller. The charging device may be capable of charging the photoconductor to a voltage. The electrophotoconductive element may also be positioned with a printer cartridge.

The light emitting source may be a laser capable of emitting light having wavelength (λ) in the range of about 350 nm to 500 nm including all values and increments therein, such as in the range of 360 nm to 480 nm, etc. As spot diameter scales linearly with wavelength, as reflected in the equation below, light having an oscillation wavelength in the range of about 350 to 500 nm may provide relatively higher print resolution than that of a wavelength in the range of about 750 to 850 nm.

d=(π/4)(λf/D)

As seen in the above equation, d may be understood the spot diameter (size) at the surface of the photoconductor, λ may be understood as the light source wavelength, f may be understood as the focal length and D may be understood as the diameter of the lens.

Accordingly, to accommodate the light emitting source, a photoconductor may have a charge generation layer including a charge generation compound sensitive to such reduced (i.e. 350 to 500 nm) wavelengths. In addition, the photoconductor may include a charge transport layer including a charge transport compound that is relatively transparent to light at such reduced wavelengths. More specifically, the charge transport compound may absorb less than about 50% of the light at such reduced wavelengths.

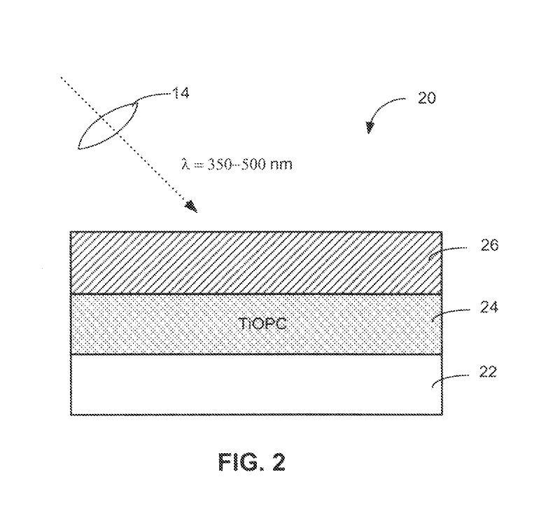

Turning to FIG. 2, as alluded to above, an organic photoconductor 20 may include a conductive substrate 22, a charge generation layer (CGL) 24 and a charge transport layer (CTL) 26 formed thereon. The CGL and CTL may be applied to the conductive substrate by various coating methods, including dip coating, spray coating, etc. Various other layers may be incorporated in between or on top of the CGL and CTL, including, for example, a protective coating on top of the CTL. The conductive substrate 22 may be formed from a metal or a metallic alloy, such as aluminum, aluminum alloys, stainless steel, copper, etc.

The CTL may include a charge transport compound and a binder material. The binder materials may include polycarbonate resins, polyester resins, polyarylate resins, butyral resins, polystyrene resins, poly(vinyl acetal) resins, diallyl phthalate resins, acrylic resins, methacrylic resins, vinyl acetate resins, phenol resins, silicone resins, polysulfone resins, styrene-butadiene resins, alkyd resins, epoxy resins, urea resins, vinyl chloride-vinyl acetate resins, either alone or in combination. The charge transport compounds may include those compounds which may be capable of supporting the injection of photogenerated holes and electrons from the CGL, which may then allow for the transport of these holes or electrons through the CTL to selectively discharge a surface charge applied to the photoconductor. Suitable charge transport compounds may include charge transport compound(s) such as diamine compounds, triarylamine compounds, pyrazoline compounds, substituted fluorene compounds, oxadiazole compounds, hydrazone compounds and combinations thereof. In addition, as alluded to above, the charge transport compound may absorb, e.g., less than 25% of the light having a wavelength in the range of about 350 to 500 nm. Stated another way, the charge transport compound may transmit 25% or more of the light having wavelengths selected from one or more wavelengths in the range of about 350 to 500 nm, including all values and increments between 25% and 100%. The charge transport compounds may be present in the range of about 5 to 60 percent by weight of the charge transport layer including all values and increments therein.

The CGL may include a binder resin and a charge generating compound which may provide a charge generating effect. The charge generating compound may include titanylphthalocyanine (TiOPC) which is illustrated below, having a molecular formula of C₃₂H₁₆N₈OTi and a molecular weight (MW) of 576.39.

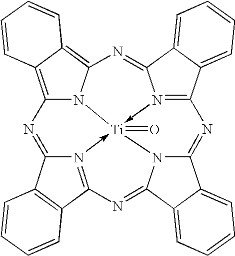

The TiOPC compound is capable of absorbing light having a wavelength in the range of about 350 to 500 nm, including all values and increments therein. The TiOPC may be present in the charge generation layer in the range of about 1 to 99% by weight, including all values and increments therein.

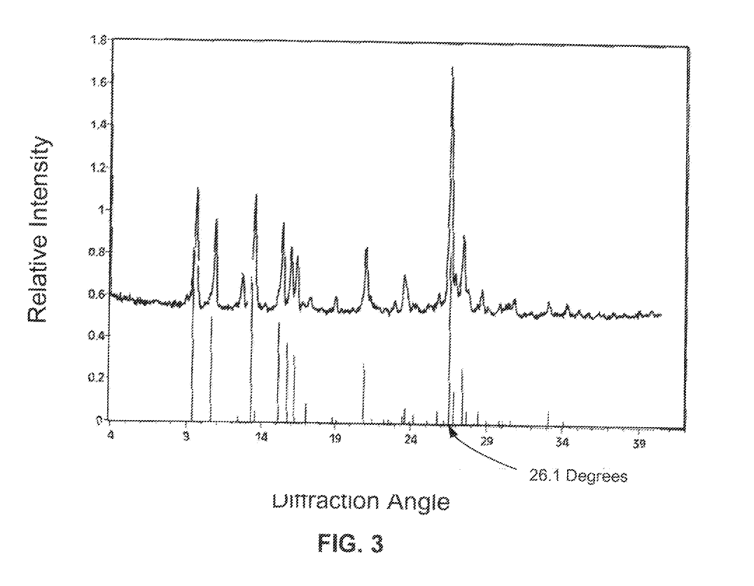

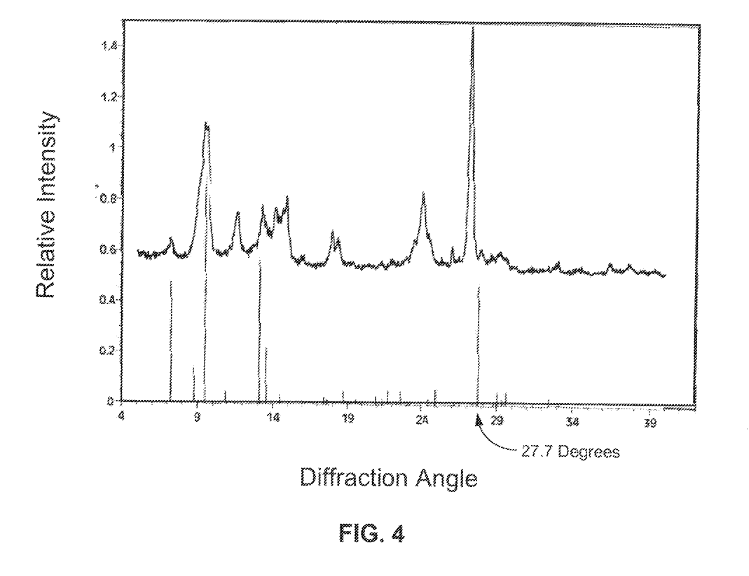

The TiOPC may be polymorphic and thereby capable of forming different crystalline forms, which may be identified by X-ray diffraction patterns, as disclosed in U.S. application Ser. No. 11/422,781, whose teachings are incorporated by reference. Such X-ray diffraction patterns may be measured by a Phillips Powder Diffractometer with scanning from 5 to 45 degrees 2 theta (2θ) at 2 degrees per minute utilizing CuK-α radiation. For example, the TiOPC may be a type I and/or IV TiOPC, wherein the type I TiOPC exhibits relatively strong intensities between 26.0 to 27.0 degrees and more specifically at 26.5 degrees, at +/− 0.4 degrees, as illustrated in FIG. 3. The strongest intensity for type I TiOPC may therefore be observed between about 26.1 to 26.9 degrees, include all values and increments therein. TiOPC type 4 exhibits relatively strong intensities between 27.0 to 28.5 degrees as illustrated in FIG. 4. More specifically, type IV TiOPC may indicate the strongest intensity of diffracted X-rays at 27.7 degrees, +/− 0.4 degrees and therefore, the strongest intensity may be observed between 27.3 and 28.1 degrees.

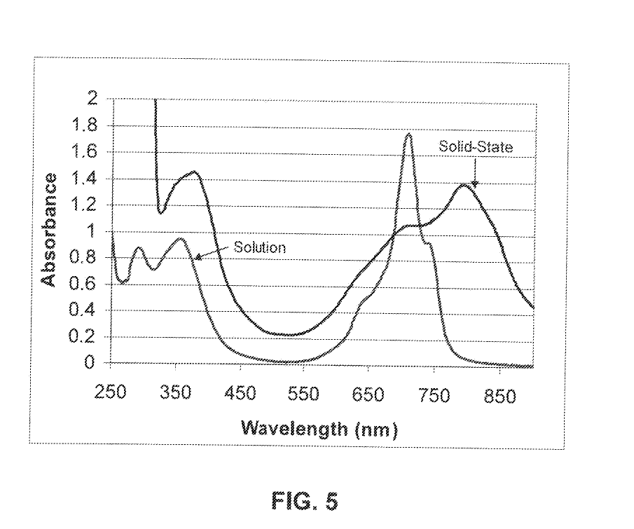

TiOPC may also be characterized by a solution UV spectrum by dissolving, e.g., type IV titanylphthalocyanine in a mixture of trifluoroacetic acid/dichloromethane (10/90 v/v). Alternatively, the solid state UV visible absorbance may be recorded by coating a dispersion prepared from type IV TiOPC onto a transparent polyester film (e.g. MYLAR®) sleeve. The optical absorption spectra may then be recorded utilizing a Genesys 2 Spectrophotometer, available from Thermospectronics, Inc. As shown in FIG. 5, the solution and solid state optical absorption properties of titanylphthalocyanine are different. A relatively sharp peak at about 670 nm (Q band) and a broader peak below 400 nm (Soret band) dominate the solution absorbance. The solid state absorbance spectrum demonstrates a broader Q band and a maximum absorbance that has shifted to 780 nm. However, the shape of the Soret band appears relatively similar to that of the solution spectrum at around 400 nm, and it may be appreciated that the intensity of the absorbance may be dependent upon the concentration of the TiOPC. In any event, and among other things, FIG. 5 identifies the ability herein of titanylphthalocyanine to serve as a charge generation compound suitable to respond to light having a wavelength of about 350 to 500 nm.

The type I and IV TiOPC may be present in combination, wherein type I TiOPC may be present in the range of about 1 to 99% by weight of the TiOPC including all values and increments therein and type IV TiOPC may be present in the range of about 99 to 1% by weight of the TiOPC including all values and increments therein. In addition, the type IV TiOPC may be present at levels greater than 99%.

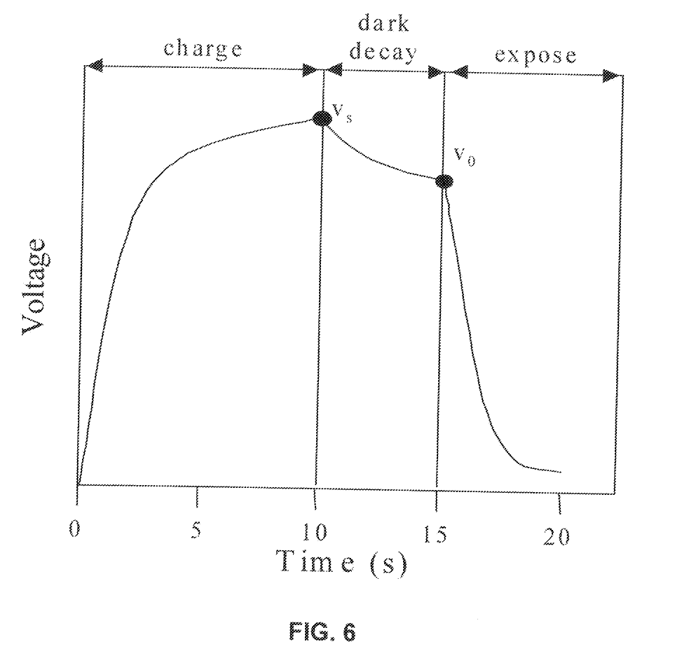

It has been presently recognized that, like the charge generating compound, the charge generation binder may also affect the ability of a photoconductor to charge and discharge. FIG. 6 illustrates an exemplary charge cycle by a plot of voltage over a period of time. The photoconductor may be charged to potential Vₛ over a time period, in this case ten seconds, by a charge generation device. Then the photoconductor may begin to dark decay, over a period of time, such as five seconds, to potential V₀. The photoconductor may then be exposed to light, such as the laser or another light source and allowed to discharge. It may therefore be appreciated, that it may be desirable in terms of the above cycle, to reduce or keep relatively small the time necessary for the photoconductor to charge and discharge to given potentials. It may also be appreciated that an increase in sensitivity of the photoconductor, i.e., the ability of the photoconductor to reach a relatively lower potential with respect to a relatively small change in charge density (energy over a given area,) may be desired.

To facilitate the development of an increase in sensitivity of the photoconductor, it has been established herein that the CGL binder may be composed of a polymer blend. A polymer blend may therefore be understood as the combination of two or more polymeric resins. Therefore, the polymer blends may involve, for example, a binary blend which includes a first polymer resin and a second polymer resin. In such an exemplary embodiment the binary polymer blends may be formulated such that they provide relatively improved charge decay characteristics in comparison to a non-blended polymer resin composition (i.e., the charge decay characteristics of one of the polymeric resins relied upon to form the blend). In addition, such charge decay improvement identified herein is accomplished with a light source at wavelengths between about 350-500 nm, including all values and increments therein. In particular, the light source may have a wavelength of about 405 nm.

In addition, and as alluded to above, the present invention contemplates the use of a ternary blend of polymer materials. Again, the three polymer resins employed in such blend may be selected, combined and configured such that one again, charge decay improvement of the type described above is accomplished with a light source having wavelengths between about 350-500 nm, including all values and increments therein, and in particular, at about 405 nm.

In the blended system of the present disclosure, examples of which follow, it has been found that when such blends are combined with a charge generating compound (e.g., TiOPC) one may provide a relatively lower charge density at half charge potential [E_{0.5(BLEND)} (μJ/cm²)] when exposed to a light source at about 350-500 nm, as compared to a single polymer resin system. Accordingly, E_{0.5(BLEND)} (μJ/cm²) may be understood herein as the energy at half charge potential or V_{0.5}. For example, as compared to a non-blended polymer system (i.e., a system containing only one of the polymer resins of the blend) the blend itself may be formulated to reduce the charge density at half charge potential. This reduction in charge density at half charge potential, which may be considered herein as a sensitivity enhancement, may amount to a relative reduction of at least about 5% or greater. For example, it is contemplated herein that it may amount to a relative reduction of about 5-50%, including all values and increments therein. Accordingly, E_{0.5(BLEND)}=(0.05)E_{0.5(POLYMER)} to (0.50)E_{0.5(POLYMER)}.

One polymer resin suitable for blending herein may include a polyacetal (PVA) whose general formula is set out below:

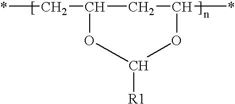

wherein R1 may be a substituted or unsubstitututed aliphatic or aromatic group, or a combined aliphatic-aromatic group. An exemplary polyacetal may therefore include polyvinyl butyral (PVB) which has the following general structure

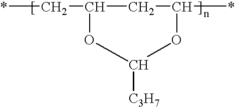

It should be appreciated that the first polymer resin, e.g. the polyacetal, may therefore include a blend of polyvinyl acetal in the range of 1-99 parts and 99-1 parts of a second polymer, including all values and increments therein. For example, the polyvinyl acetal may be present at about 1-50 parts, wherein the second polymer may be present at 50-99 parts. In addition, it may also be appreciated that in the case of a ternary blend, each polymer resin may itself be present at a level of about 1-50 parts, including all values and increments therein, wherein the mixture of all three resins provides 100 parts of blended binder resin suitable for use in the charge generation layer. Accordingly, it may be appreciated that regardless of the relative proportions of resins employed to increase sensitivity, the blend may be combined with the TiOPC additive to form the CGL as noted above.

The second polymer resin may specifically include a benzene derivative, such as a phenolic resin, and more specifically, an epoxy novolac polymer and/or poly(4-hydroxystyrene) (PHS). A phenolic resin may be understood herein as a reaction product of phenol with formaldehyde under either acidic or basic conditions and may therefore have the following general structure:

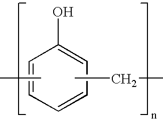

Novoloc therefore is a general reference to a specific type of phenolic resin that relies upon the acid catalyzed reaction of phenol with formaldehyde with the molar ratio of formaldehyde to phenol of less than one. Accordingly, in one exemplary embodiment, the binder may include a polyvinyl acetal resin in combination with a phenolic resin, such as an epoxy novolac, represented by the formula below:

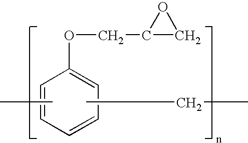

One exemplary epoxy novolac is available under the trade name EPON™.

In a further embodiment, the charge generation binder may include polyvinyl acetal in combination with a poly(hydroxystyrene) (PHS), which is reference to a polystyrene repeating unit that may contain one or more hydroxyl groups on the aromatic ring. The poly(hydroxystyrene) may be represented by the formula below, which illustrates p-hydroxystyrene. It is contemplated that the hydroxy functionality may be located at positions ortho and meta on the illustrated benzene ring.

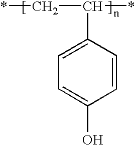

As noted above, the binder herein may also include additional polymers such as a siloxane resin, which relies upon the repeating unit of silicon and oxygen as illustrated below:

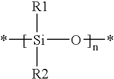

wherein R1 and/or R2 may be aliphatic or aromatic and be substituted or unsubstituted. Exemplary siloxane polymers may include poly(methylphenyl)siloxane (PMPS) represented by the formula below, or even poly(dimethyl-diphenyl)siloxane, or polydimethylsiloxane.

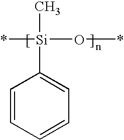

The CGL and CTL formulations described herein may be evaluated using a rotating disk electrometer (RDE), such as a Monroe Static Charge Analyzer Model 276A, using a tungsten light source with a maximum at 405 nm with an 80 nm bandwidth. This then identifies the overall discharge behavior of the coatings in the presence of light at a wavelength of 405 nm (i.e. the energy in μJ/cm² at half charge potential or V_{0.5} for a given amount of light energy).

### EXAMPLES

The examples included herein are for illustrative purposes only and are not meant to limit the scope of this disclosure or the claims appended herein.

Specifically, samples were prepared for analysis by a rotating disc electrometer (RDE). Specifically, 5 inch×10 inch sheets of anodized aluminum MYLAR® were taped onto aluminum substrates. Charge generation layers were coated over the aluminum Mylar via dip coating. Concentration of the pigment was (e.g., TiOPC) was about 45% by weight. The optical density was adjusted to about 1.2 by changing the coating speed. The charge transport solution (20 percent solids) was prepared by dissolving 35 parts TTA, 5 parts TAPC and 60 parts polycarbonate Z in a solvent blend of THF/1,4-dioxane (75/25 w/w). The resulting solutions were coated over the charge generation layer via dip coating and dried at about 100° C. for about 1 hour. The coating thickness was adjusted to about 25 microns by changing the coating speed. The RDE samples may then be cut into circles of about 1.0 inch diameter. Conductive silver paint is then placed onto an edge of the circle for electrical testing.

Following the above general procedure, charge generation layers were prepared wherein the ratio of phenolic resin (epoxy novolac) to polyacetal (polyvinylbutyral) was varied from 20 to 50 parts. The performance of the photoconductors containing a polymer blend of poly(vinyl butyral) to epoxy novolac were tested at the following ratios: 20/80; 25/75; 33/67 and 50/50 parts. As noted above, the presence of phenolic resin (epoxy novolac) was observed to improve the sensitivity of the photoconductor at all ratios, and all samples exhibited relatively similar electrical sensitivities.

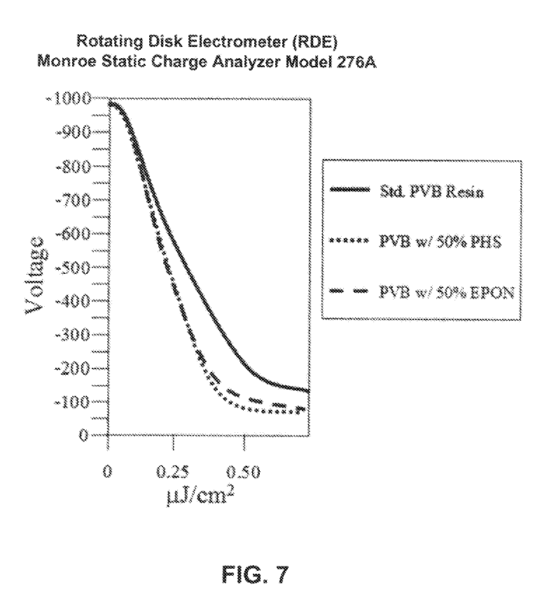

Attention is therefore directed to FIG. 7 which is a plot of exemplary charge decay curves which indicates the discharge voltage as a function of light energy centered at 405 nm (plus or minus 20 nm) by employing a tungsten light source. Discharge properties were measured on a Monroe Static Charge Analyzer Model 276A. The discharge was obtained as a plot of negative photconductor voltage (−V) against energy (μJ/cm²). Table 1 below therefore provides a comparison for the value of energy at half charge potential (V_{0.5}) and the indicated percent sensitivity enhancement relative to a charge generation layer containing only poly(vinyl butyral). The indicated samples all contained 45% by weight of charge generation compound (TiOPC). The percent sensitivity enhancement represents the relative reduction in the value at the half charge potential. For example, in the case of PVB/PHS/PMPS, with 50 parts PVB, 45 parts PHS and 5 parts PMPS, the value at half charge potential was 0.22 μJ/cm². Poly(vinyl butyral) indicated a value at half charge potential of 0.27 μJ/cm². The percent sensitivity enhancement is therefore 0.22 μNJ/cm² divided by 0.27 μJ/cm² or 19%. It therefore may be observed from both FIG. 7 and Table 1 that the energy at half charge potential of the blends [E_{0.5(BLEND)}] may be less than the energy at half charge potential of the poly(vinylacetal) component [E_{0.5(PVA)}], which poly(vinylacetal) component may include poly(vinylbutyral). Accordingly, E_{0.5(BLEND)}=(0.05)E_{0.5(PVA)} to (0.50)E_{0.5(PVA).} In addition, it can be observed that in the case of the PVB/EPON blend, the parts of PVB was varied between 50-80 parts and the corresponding parts of EPON varied from 50-20 parts, with the indicated sensitivity enhancement.

TABLE 1

| Charge Generation Resin | | |
|---|---|---|
| Formulation | E_{0.5} (μJ/cm²) | % Sensitivity Enhancement |
| PVB | 0.27 | — |
| PVB/PHS/PMPS (50/45/5) | 0.22 | 19 |
| PVB/EPON (50/50) | 0.21 | 22 |
| PVB/EPON (75/25) | 0.21 | 22 |
| PVB/EPON (67/33) | 0.22 | 19 |
| PVB/EPON (80/20) | 0.20 | 26 |

The foregoing description of several methods and an embodiment of the invention has been presented for purposes of illustration. It is not intended to be exhaustive or to limit the invention to the precise steps and/or forms disclosed, and obviously many modifications and variations are possible in light of the above teaching. It is intended that the scope of the invention be defined by the claims appended hereto.

What is claimed is:

1. An electrophotoconductive element comprising a conductive substrate, a charge generation layer including a charge generating compound and a charge transport layer,
said charge generating layer comprises a first polymeric resin and a second polymer resin forming a blend wherein said blend provides an energy at half charge potential E_{0.5(BLEND)} upon exposure to light at a wavelength of about 350-500 nm;
said first polymer resin provides an energy at half charge potential E_{0.5(POLYMER)} upon exposure to light at a wavelength of about 350-500 nm;
wherein E_{0.5(BLEND)}<E_{0.5(POLYMER)}.

2. The electrophotoconductive element of claim 1 wherein E_{0.5(BLEND)}=(0.05)E_{0.5(POLYMER)} to (0.50)E_{0.5(POLYMER)}.

3. The electrophotconductive element of claim 1 wherein said first polymer resin comprises poly(vinyl butyral) of the formula:

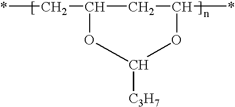

4. The electrophotoconductive element of claim 1 wherein said second polymer resin comprises a phenolic resin having the structure:

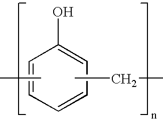

5. The electrophotoconductive element of claim 1 wherein said second polymer resin comprises an epoxy novolac resin having the structure:

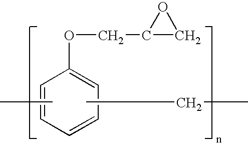

6. The electrophotoconductive element of claim 1 further including a third polymer resin component.

7. The electrophotoconductive element of claim 1 wherein said charge generating compound comprises titanylphthalocyanine.

8. The electrophotoconductive element of claim 1 positioned within a printer cartridge.

9. The electrophotoconductive element of claim 1 positioned within an image forming device.

10. An electrophotoconductive element comprising a conductive substrate, a charge generation layer including a change generating compound and a charge transport layer, wherein said charge generating layer comprises poly(vinyl acetal) having the following formula: 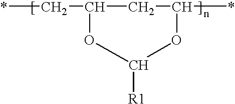
where R1 may be a substituted or unsubstitututed aliphatic or aromatic group or a combined aliphatic-aromatic group;
a second polymer resin forming a blend, said second polymer resin having the formula: 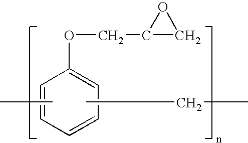
said blend providing an energy at half charge potential E_{0.5(BLEND)} upon exposure to light at a wavelength of about 350-500 nm;
said polyvinyl(acetal) providing an energy at half charge potential E_{0.5(PVA)} upon exposure to light at a wavelength of about 350-500 nm;
wherein E_{0.5(BLEND)}<E_{0.5(PVA).}

11. The electrophotoconductive element of claim 10 wherein E_{0.5(BLEND)}=(0.05)E_{0.5(PVA)} to (0.5)E_{0.5(PVA)}.

12. The electrophotoconductive element of claim 10 wherein said charge generating compound comprises titanylphthalocyanine.

13. The electrophotoconductive element of claim 10 further comprising a third polymer resin.

14. The electrophotoconductive element of claim 10 positioned within a printer cartridge.

15. The electrophotoconductive element of claim 10 positioned within an image forming device.

16. A method for improving the spectral sensitivity of a photoconductor containing a conductive substrate, a charge generation layer including a charge generating compound and a charge transport layer comprising:
forming said charge generation layer by combining a first polymer resin and second polymer resin to provide a blend including said charge generating compound;
wherein said first polymer resin indicates an energy at half charge potential E_{0.5(POLYMER)} upon exposure to light at a wavelength of about 350-500 nm;
wherein said blend indicates an energy at half charge potential E_{0.5(BLEND)} upon exposure to light at a wavelength of about 350-500 nm;
wherein said second polymer resin of said blend is selected to provide that E_{0.5(BLEND)}<E_{0.5(POLYMER).}

17. The method of claim 16 wherein said first polymer resin comprises poly(vinyl acetal) having the following formula: 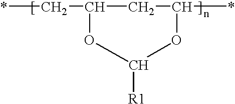
where R1 may be a substituted or unsubstitututed aliphatic or aromatic group or a combined aliphatic-aromatic group.

18. The method of claim 16 wherein said second polymer resin comprises a phenolic resin having the structure:

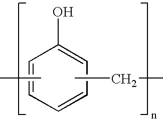

19. The method of claim 16 wherein said second polymer resin comprises an epoxy novolac resin having the structure:

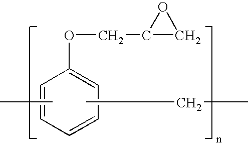

20. The method of claim 16 wherein E_{0.5(BLEND)}=(0.05)E_{0.5(POLYMER)} to (0.5)E_{0.5(POLYMER)}.
